(19) United States
(12) Patent Application Publication
(10) Pub. No.: US 2009/0037344 A1
(43) Pub. Date: Feb. 5, 2009

(54) Multiple Fund Structure For Mutual Funds Based On A Matrix Design Created By The Intersection Of Multiple Risk/Reward Investment Strategy Models And Multiple Fixed Percentage Rate Distribution Schedules For Investment Funds

(76) Inventor: Keith Diffenderffer, Chula Vista, CA (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/833,411

(22) Filed: Aug. 3, 2007

(51) Int. Cl. G06Q 40/00

(52) U.S. Cl. 705/36 R

(57) ABSTRACT

A Multiple Fund Structure For Investment Funds Based On A Matrix Design Created By The Intersection Of Multiple Risk/Reward Investment Strategy Models And Multiple Fixed Percentage Rate Distribution Schedules For Investment Funds allows an investment company to serve the diverse needs of the large population of retirement income investors by developing a series of strategic asset allocation portfolios each with a menu of fixed rate distribution choices. The matrix structure offers an easy to understand design model.

This application claims benefit of and should be cross-referenced to U.S. Utility patent application Ser. No. 11/679,144; The Defined Fixed Percentage Rate Distribution Schedule For Open End Mutual Funds.

This application claims benefit of and should be cross-referenced to U.S. Utility patent application Ser. No. 11/535,650; Multiple Fixed Rate Distribution Schedules From A Single Investment Strategy Model

A Multiple Fund Structure For Investment Funds Based On A Matrix Design Created By The Intersection Of Multiple Risk/Reward Investment Strategy Models And Multiple Fixed Percentage Rate Distribution Schedules For Investment Funds allows an investment company to satisfy the broad spectrum of needs for the retirement income investor. The concept recognizes the retirement income investor represents a very large population with very different individual risk tolerances and income needs. The matrix design allows the investor to combine the appropriate risk/reward investment strategy model that best represents the investment goal and the appropriate fixed percentage rate distribution schedule that fulfills the income needs. This matrix design provides a rational approach to creating a menu of retirement income investment fund solutions organized around a central unifying theme of managing portfolios for volatility control, total return and integrating an easy to understand prospectus mandated distribution mechanism.

What is claimed is:

1. A multiple fund structure for investment funds based on: A Matrix Design Created By The Intersection Of Multiple Risk/Reward Investment Strategy Models And Multiple Fixed Percentage Rate Distribution Schedules For Investment Funds recognizes a long duration retirement income strategy that will operate successfully regardless of economic, interest rate and equity market cycles can not be achieved utilizing a “yield” or earned income investment model. The dual challenge of providing an immediate cash-flow and long-term growth of that cash-flow predicates utilizing an integrated diversified portfolio of ownership assets that may create little or no earned income or “yield” based distributions; but retains an inherent inflation adjustment valuation accelerator and then arbitrarily assigns a rational distribution mechanism to engineer consistent long duration cash flow. Because the distribution mechanism employed is an arbitrary device and not reflective or conditioned on earned distributions, and because the population being served is very large and very diverse multiple alternative schedules of distributions can be assigned to a single strategic target portfolio. Similarly, because the population being served is very large and very diverse and distributions are engineered by device and therefore are independent of “yield” or earned income considerations multiple strategic allocation models reflecting a variety of volatility/total return target models can be constructed. The integration of the multiple distribution schedules and the multiple asset allocation models creates a matrix defining the individual fund offerings.

| Strategic Model | Income | Balanced Income | Equity Income |
|---|---|---|---|
| R | 4% | 4% | 4% |
| A | 5% | 5% | 5% |
| T | 6% | 6% | 6% |
| E | 7% | 7% | 7% |

This matrix structure for distribution funds provides a significant benefit to the retirement income investor because it offers a coherent easy to understand rationale for transforming low “yield” risk controlled asset allocation portfolios into cash flow producing infinite duration income vehicles.
